(19) United States
(12) Patent Application Publication
(10) Pub. No.: US 2025/0314783 A1
(43) Pub. Date: Oct. 9, 2025

(54) NAVIGATION SATELLITE SIGNAL REAL-TIME GENERATION SYSTEM USING INTEGRATED DEAD RECKONING FUNCTION

(71) Applicant: Hyun Soo KIM, Gunpo-si (KR)

(72) Inventor: Hyun Soo KIM, Gunpo-si (KR)

(21) Appl. No.: 18/715,585

(22) PCT Filed: Dec. 2, 2022
(86) PCT No.: PCT/KR2022/019548

§ 371 Date: Nov. 14, 2024

(30) Foreign Application Priority Data
Dec. 2, 2021 (KR) 10-2021-0170864

(51) Int. Cl. G01S 19/42; G01C 21/12; G01S 19/52

(52) U.S. Cl. CPC G01S 19/42; G01C 21/12; G01S 19/52

(57) ABSTRACT

A navigation satellite signal real-time generation system using an integrated dead reckoning function is proposed. The navigation satellite signal real-time generation system may include a navigation unit for generating position coordinates of the moving object by using the integrated dead reckoning function and a navigation satellite signal real-time generation device for exchanging data with the navigation unit in real time and generating the navigation satellite signals on the basis of the position coordinates and real-time clock information.

### TECHNICAL FIELD

The present disclosure relates to a navigation satellite signal real-time generation system using an integrated dead reckoning (DR) function and, more particularly, to a navigation satellite signal real-time generation system for converting coordinate values that change with time into RF signals in real time.

### BACKGROUND ART

Conventionally, a Global Navigation Satellite System (GNSS) such as GPS, GLONASS, BEIDOU, or a Regional Navigation Satellite System (RNSS) such as QZSS, NAVIC, and Korean Positioning System (KPS) may accurately calculate positions from only a receiver, which is present in an outdoor environment where signals from navigation satellites located outside the earth can be normally and directly received. That is, the existing satellite navigation positioning method is a technology that may determine the position, altitude, and speed of a moving or fixed object throughout the earth by using satellite signals transmitted from a plurality of artificial satellites. Such a satellite navigation system was developed for military purposes, but in recent years, this system has been used in a wide range of fields not only for navigation for all means of transportation and for surveying, agriculture, and earth science, but also for national welfare and crisis management systems such as search and rescue of emergency patients, position tracking of criminals, and response to natural disasters.

Meanwhile, in a case where a user's position is determined through a satellite navigation system, it is important to calculate the corresponding user's position by accurately analyzing satellite signals received from satellites. However, the satellite signals received from the satellites include orbital errors of the satellites, clock errors between a receiver and the satellites, errors due to the ionosphere and the troposphere, and/or multipath errors, thereby usually causing the errors of several meters or tens of meters. In order to solve such problems, recently, differential GNSS (DGNSS), using various positioning correction techniques such as differential GPS (DGPS) or real time kinematic (RTK), has been developed.

However, in a case where a user's position indoors is determined through a satellite navigation system even when the positioning correction technique (DGNSS) described above is used, it is impossible to calculate the user's position because satellite signals do not reach from the satellites. Accordingly, since it is impossible to receive the satellite signals indoors, such a positioning correction technique is not actually applicable.

In order to solve this problem, recently, research is being actively conducted to perform positioning for a user located indoors by applying technologies including: a mixed positioning technology using MEMS inertial sensors; an image positioning technology using LiDARs or cameras; and radio navigation technology using a trilateration method that is similar to that of a satellite navigation system and applied with the signal processing of wireless communication systems such as Wi-Fi, Bluetooth, and ultra-wideband (UWB), which are developed for communication. However, these technologies are only used as supplements, and do not completely replace the satellite navigation system.

In addition, in order to solve the above-described problems, technology is being developed to generate and transmit navigation satellite signals on the ground instead. However, the related art as such also had a problem of not working properly when the exterior of a moving object is made of a thick steel plate or there are many obstacles in communication paths. Furthermore, since the related art as such was designed for the navigation satellite signals to point only one spot, it is difficult to continuously perform positioning indoors, and thus, processing digital I/Q data is unable to be done in real time. In addition, the existing technology configured to generate navigation satellite signals for indoors has a disadvantage in that a plurality of separate devices (e.g., coaxial cables, optical cables, Ethernet cables, RF-to-optical cables, optical-to-RF cables, or the like for wiring) has to be provided indoors such as underground parking lots and tunnel sections.

Accordingly, the demand for various technologies to solve the above-described problems has increased in the corresponding industry.

### DISCLOSURE

### Technical Problem

The present disclosure is a technology proposed to solve the problems of the related art as described above, and an objective of the present disclosure is not only to solve the problem that connecting wiring and cables to each other is required due to the related art treated as a facility, but also provide a technology for generating RF signals in real time by incorporating a real-time signal generation technology whenever changing coordinates are input.

### Technical Solution

A navigation satellite signal real-time generation system using an integrated dead reckoning function is proposed. The navigation satellite signal real-time generation system may include a navigation unit for generating position coordinates of the moving object by using the integrated dead reckoning function; and a navigation satellite signal real-time generation device for exchanging data with the navigation unit in real time and generating the navigation satellite signals on the basis of the position coordinates and real-time clock information.

### Advantageous Effects

The related art did not have a function of generating navigation satellite RF signals in real time, so there was a limitation that only one fixed coordinate entered can be converted into a navigation satellite RF signal. However, according to the exemplary embodiment of the present disclosure, a time interval between a time point at which real-time I/Q data is generated and a time point at which RF signals are generated is realized within 500 ms (i.e., the time it takes for received position coordinates to be converted into the RF signals is realized within 500 ms), whereby even when a moving object updates its continuously changing position coordinates at one-second intervals, accurate navigation satellite RF signals may be generated according to the updated position coordinates.

According to the exemplary embodiment of the present disclosure, real-time positioning based on navigation satellite signals may be performed, so as to match the movement of a moving object through a smartphone or navigation satellite signal receiver of a passenger on board the moving object.

According to the exemplary embodiment of the present disclosure, even when a target moving object that is a target of positioning enters the inside of a long tunnel, position coordinates may be generated through an integrated dead reckoning function and be converted and transmitted into navigation satellite RF signals, so a user is able to use position-based services on the basis of a satellite navigation system even within the tunnel as if the user were in an environment where navigation satellite signals are normally received.

### DESCRIPTION OF DRAWINGS

FIG. 1 is a view schematically illustrating a positioning system according to the related art.

FIG. 2 is a block diagram illustrating a navigation satellite signal real-time generation system using an integrated dead reckoning function according to an exemplary embodiment of the present disclosure.

FIG. 3 is a conceptual view illustrating a method of determining quality by a navigation satellite signal quality determination unit according to the exemplary embodiment of the present disclosure.

FIG. 4 is a view illustrating an operation of navigation satellite signal real-time generation and a clock graph according to the exemplary embodiment of the present disclosure.

FIG. 5 is a view illustrating an applied exemplary embodiment according to the exemplary embodiment of the present disclosure.

FIG. 6 is a view illustrating an applied exemplary embodiment according to the exemplary embodiment of the present disclosure.

### BEST MODE

A navigation satellite signal real-time generation system using an integrated dead reckoning function is proposed. The navigation satellite signal real-time generation system may include a navigation unit for generating position coordinates of the moving object by using the integrated dead reckoning function; and a navigation satellite signal real-time generation device for exchanging data with the navigation unit in real time and generating the navigation satellite signals on the basis of the position coordinates and real-time clock information.

According to the exemplary embodiment, the navigation unit may include: a receiver for receiving satellite navigation information for a plurality of navigation satellites; one or more sensors each measuring at least one of acceleration of the moving object, a travelling speed of the moving object, or movement information of the moving object; an integrated speed calculation unit for calculating the speed of the moving object on the basis of one or more sensor values measured from the one or more sensors; an integrated direction calculation unit for calculating a direction of the moving object on the basis of the one or more sensor values measured from the one or more sensors; and a dead reckoning position calculation unit for calculating the three-dimensional position coordinates of the moving object on the basis of the calculated speed of the moving object and the calculated direction of the moving object.

According to the exemplary embodiment, the navigation satellite signal real-time generation device may include: an I/Q signal real-time generation unit for generating digital In-phase Quadrature-phase (IQ) signals by using the three-dimensional position coordinates received from the dead reckoning position calculation unit; and an RF converter for converting the digital IQ signals generated by the I/Q signal real-time generation unit into radio frequency (RF) signals on the basis of the real-time clock information.

According to the exemplary embodiment, the navigation unit may further include a navigation satellite signal quality determination unit for receiving the navigation satellite signals transmitted from the receiver, determining quality of the navigation satellite signals, and requesting the dead reckoning position calculation unit to generate the position coordinates in a case where the determined quality of the navigation satellite signals is poor.

According to the exemplary embodiment, the system may be configured to generate the navigation satellite signals at least once or more per second by setting, within 500 ms, a time interval between a time point at which the navigation unit generates the position coordinates and a time point at which the navigation satellite signal real-time generation device generates the navigation satellite signals.

### Mode for Invention

Hereinafter, the present disclosure will be described in detail. The terms or words used in the present specification and claims are not to be construed as being limited to their ordinary or dictionary meanings, and should be interpreted as meanings and concepts corresponding to the technical spirit of the present disclosure based on the principle that inventors may properly define the concept of a term in order to best describe their disclosure. Accordingly, the configuration shown in the exemplary embodiment described in the present specification is only the most preferred exemplary embodiment of the present disclosure, and do not represent all the technical ideas of the present disclosure, and accordingly, it should be appreciated that there may be equivalents and modifications at the time when the present application is filed.

The present technology is the resultant output of “Development of a 3G-level GNSS Signal Generation System for Urban Areas” project of the Land, Infrastructure and Transport Technology Commercialization Supporting (R&D) Services of Korea Agency for Infrastructure Technology Advancement (KAIA) under the Ministry of Land, Infrastructure and Transport of the Republic of Korea from Apr. 1, 2021 to Dec. 31, 2021 (Name of the project-performing organization: GPS Family, project identification number: 1615012031, and project number: 161315)

“Navigation satellite signals” in the present disclosure may be used as a general term for signals generated according to various technologies for measuring the position of a specific object by using satellites. In addition, the “navigation satellite signals” may also be simply referred to as “navigation signals”, “satellite signals.”, or the like. For example, a technology for measuring the position of the specific object by using the satellites may be performed through a system, such as a “Global Navigation Satellite System (GNSS)”, a “Regional Navigation Satellite System (RNSS)”, etc. In the present specification, the GNSS may also be referred to as an earth satellite navigation system, and the RNSS may also be referred to as a regional satellite navigation system. In addition, the GNSS and RNSS may be collectively referred to as a “satellite navigation system”, “navigation satellite system”, or the like.

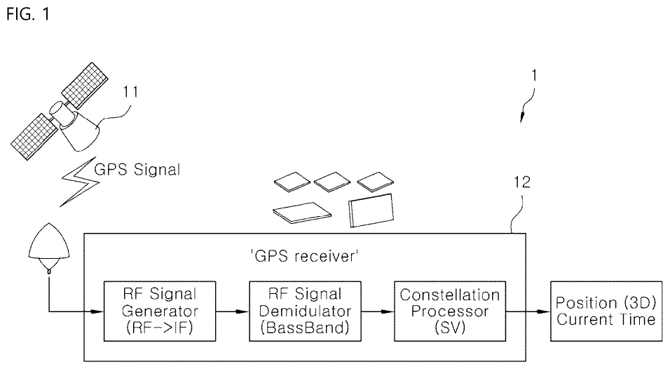

FIG. 1 is a view schematically illustrating a positioning system according to the related art.

As shown in FIG. 1, in a positioning system 1 according to the related art, a navigation satellite signal receiver 12 of a moving object that is a target of positioning may receive navigation satellite signals including satellite navigation information from a plurality of navigation satellites 11 in order to perform the positioning at a specific time point (e.g., a current time relative to the moving object) and at a specific positioning point (e.g., a current position of the moving object). In the exemplary embodiment, the navigation satellite signal receiver 12 of the moving object may receive navigation satellite signals (e.g., GPS signals) regarding the current time and current position from the plurality of navigation satellites 11.

In the positioning system 1 according to the related art, the navigation satellite signal receiver 12 of the moving object may sample analog Radio Frequency (RF) signals of the received navigation satellite signals into digital Intermediate Frequency (IF) signals, so as to extract In-phase Quadrature-phase (IQ) data (or, referred to as “IQ signals”) from the navigation satellite signals. Hereinafter, in the present specification, the IF signals in digital mode may be simply referred to as “digital IF signals”.

Next, the positioning system 1 according to the related art performs baseband signal processing to distinguish satellite broadcast wave signals and PRN code-specific signals according to pseudorandom noise (PRN) codes from the extracted IQ data, and extracts satellite navigation information (i.e., an ephemeris, an almanac, etc.) and satellite measurement information as the results of the baseband signal processing.

The positioning system 1 according to the related art calculates a position for a specific time and specific positioning point of the moving object that is the target of positioning by using the extracted satellite navigation information and satellite measurement information.

However, the positioning system 1 according to the related art as such was devised to calculate a position outdoors where receiving navigation satellite signals is stable, but had a problem of not being applicable indoors where navigation satellite signals were not received.

In contrast, the embodiment of the present disclosure uses not only a navigation unit for calculating position coordinates through known fixed position coordinates or an integrated dead reckoning function, but also a device for generating navigation satellite signals by using real-time clock information while interworking with the navigation unit in real time (i.e., while exchanging data in real time), so that the navigation satellite signals may be generated even when a moving object moves through a shaded area where the navigation satellite signals cannot be received. The present disclosure may also be used for position tracking required for emergency rescue in situations such as emergency or fire.

In the present disclosure, “real-time clock information” may be used as a term referring to information about logic states when a logic state H (high, logic 1) and a logic state L (low, logic 0) change periodically. The real-time clock information may be information used by a plurality of components to synchronize time.

In the present disclosure, “moving object” may be not only an automobile but also a moving object such as a railroad and a bus used to provide passenger services, or a moving object such as a hospital wheelchair used to provide convenience services.

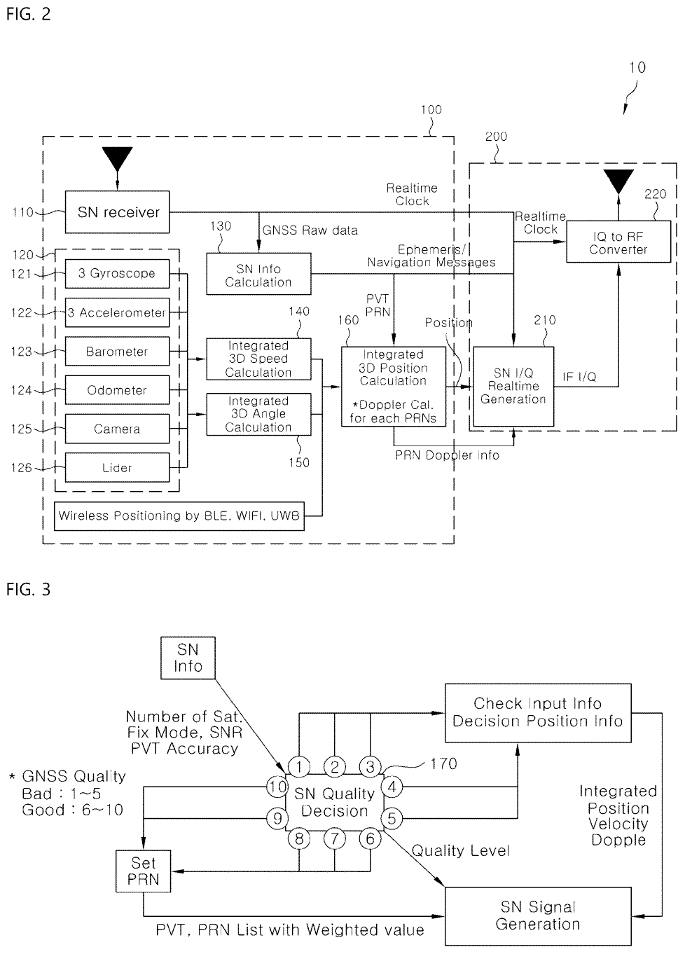

FIG. 2 is a block diagram illustrating the navigation satellite signal real-time generation system 10 using the integrated dead reckoning function according to the exemplary embodiment of the present disclosure.

As shown in FIG. 2, the navigation satellite signal real-time generation system 10 using the integrated dead reckoning function according to the exemplary embodiment of the present disclosure may include: a navigation unit 100 for generating position coordinates of a specific moving object (hereinafter also referred to as a target object) that is a target of positioning by using the integrated dead reckoning function; and a navigation satellite signal real-time generation device 200 for exchanging data in real time with the navigation unit 100 and generating navigation satellite signals on the basis of the position coordinates and real-time clock information of the specific moving object, which are obtained by the navigation unit 100.

Specifically, the navigation unit 100 may include: a receiver 110 for receiving satellite navigation information for a plurality of navigation satellites of a target moving object; one or more sensors 120; a satellite navigation information calculation unit 130; an integrated speed calculation unit 140 for calculating a speed of the moving object on the basis of various kinds of input information; an integrated direction calculation unit 150 for calculating direction information of the moving object on the basis of the various kinds of input information; and a dead reckoning position calculation unit 160 for calculating a position of the target moving object on the basis of a calculation result of each of the integrated speed calculation unit 140 and the integrated direction calculation unit 150. In addition, the navigation unit 100 may further include a navigation satellite signal quality determination unit (not shown) for distinguishing the quality of each navigation satellite signal.

The receiver 110 is a component for receiving satellite navigation information of a target moving object for a plurality of navigation satellites, and may receive the satellite navigation information for the plurality of navigation satellites from a navigation satellite signal reception device, a satellite navigation information provision system, or the like, which is installed outdoors. The receiver 110 may transmit the received information to the satellite navigation information calculation unit 130.

The one or more sensors 120 may include: a gyroscope sensor 121 for measuring an angular velocity; an acceleration sensor 122 for measuring acceleration; a barometer 123 for measuring an altitude; an odometer 124 for measuring vehicle speed information provided by vehicle pulses or CAN speed communication and collected from a vehicle when a specific moving object is the vehicle; a camera 125 for providing path information including information on shape points, intersection points, connection points, or connection lines between points, and/or the like of a driving path extracted or generated from a map; a LIDAR 126 for providing image information to indicate movement information of the moving object; and/or the like. The one or more sensors 120 may be configured to transmit sensed information to the integrated speed calculation unit 140 and the integrated direction calculation unit 150.

The integrated speed calculation unit 140 may calculate a speed of the moving object on the basis of the information received from the one or more sensors 120. The integrated direction calculation unit 150 may generate direction information of the moving object on the basis of the information received from the one or more sensors 120.

The dead reckoning position calculation unit 160 may calculate the three-dimensional position coordinates of the target moving object on the basis of the information received from the satellite navigation information calculation unit 130, the integrated speed calculation unit 140, and the integrated direction calculation unit 150. In addition, the dead reckoning position calculation unit 160 may additionally receive position information of the target moving object from a wireless positioning unit 145. The wireless positioning unit 145 may transmit the position information of the target moving object to the dead reckoning position calculation unit 160 through a communication system such as WiFi, Bluetooth, UWB, and CDMA.

The dead reckoning position calculation unit 160 may calculate the three-dimensional position coordinates of the target moving object by applying the Doppler technique to each of a plurality of PRN code-specific signals.

Meanwhile, the navigation satellite signal real-time generation device 200 may include an In-phase Quadrature-phase (I/Q) signal real-time generation unit 210 and an RF converter 220.

In the exemplary embodiment, the I/Q signal real-time generation unit 210 may generate navigation satellite signals in real time by using three-dimensional position coordinates, satellite navigation information, an ephemeris, navigation messages, and real-time clock information, which are input for the target moving object. Specifically, the I/Q signal real-time generation unit 210 may generate digital I/Q data having intermediate frequencies (IFs) by receiving the real-time clock information from the receiver 110, the information such as the ephemeris and navigation messages generated from the satellite navigation information calculation unit 130, and the three-dimensional position coordinates and PRN Doppler information of the moving object from the dead reckoning position calculation unit 160, respectively. Here, the PRN Doppler information may refer to information including a Doppler calculation value for each satellite and calculated by the dead reckoning position calculation unit 160.

The RF converter 220 may generate satellite signals by converting the digital I/Q data having the intermediate frequencies (IF) generated by the I/Q signal real-time generation unit 210 into RF signals on the basis of the real-time clock information. The RF converter 220 may receive the real-time clock information from the receiver 110 included in the navigation unit 100.

In a case where there is a plurality of navigation satellites selected, the RF converter 220 may integrate IF data from each of the plurality of navigation satellites and convert the IF data into RF signals. The RF converter 220 may simultaneously transmit the RF signals to the plurality of navigation satellites selected. The RF converter 220 may allow the satellite signals to be emitted by transmitting the converted RF signals (i.e., the satellite signals) to a specific satellite navigation RF antenna connected to the corresponding navigation unit 100.

FIG. 3 is a conceptual view illustrating a method of determining quality by a navigation satellite signal quality determination unit according to the exemplary embodiment of the present disclosure.

The navigation satellite signal quality determination unit 170 may be a component of the navigation unit 100 shown in FIG. 2. The navigation satellite signal quality determination unit 170 may receive navigation satellite signals from the receiver 110 and determine the quality of each navigation satellite signal.

In a case of determining that the quality of the navigation satellite signals is good, the navigation satellite signal quality determination unit 170 may use the received navigation satellite signals, and in a case of determining that the quality of the navigation satellite signals is poor, the navigation satellite signal quality determination unit 170 may generate navigation satellite signals on the basis of position coordinates.

In the exemplary embodiment, the navigation satellite signal quality determination unit 170 may determine whether the quality of received signals is good or poor on the basis of an average signal-to-noise ratio (SNR), the number of satellites (nSat), or PVT accuracy of the navigation satellite signals received during a predetermined first time. Here, the nSat refers to the number of satellites in fix mode, and the PVT accuracy is a coefficient indicating accuracy degradation depending on the celestial arrangement of a GNSS, and represents the accuracy of a three-dimensional positioning result and a time point.

The navigation satellite signal quality determination unit 170 may determine that quality is poor in a case where an average SNR of the received navigation satellite signals is less than or equal to 25 dB, and may determine that quality is good in a case where an average SNR of the received navigation satellite signals is greater than 25 dB.

The navigation satellite signal quality determination unit 170 may determine that quality is poor in a case when nSat of received navigation satellite signals is one to five, and determine that quality is good in a case when nSat of received navigation satellite signals is six or more.

The navigation satellite signal quality determination unit 170 may determine that quality is poor in a case where PVT accuracy (i.e., GDOP) of received navigation satellite signals is greater than or equal to one, and determine that quality is good in a case where PVT accuracy (GDOP) of received navigation satellite signals is less than one.

The navigation satellite signal quality determination unit 170 may determine the final quality of received navigation satellite signals by applying respective weights to the average signal-to-noise ratio (SNR), nSat, and PVT accuracy of the determined navigation satellite signals and performing weighted summation therefor.

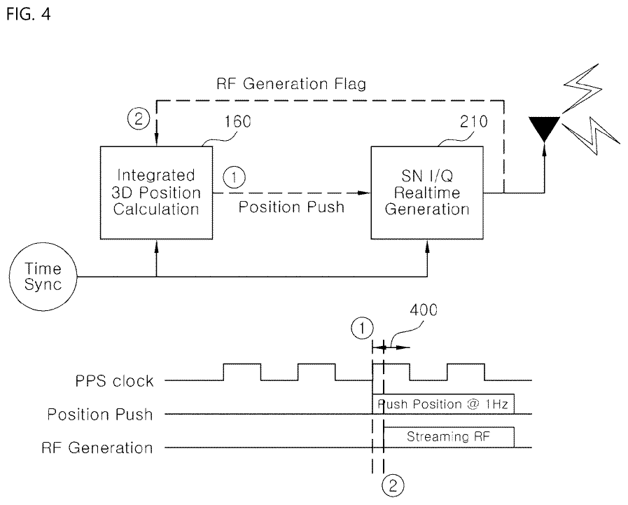

FIG. 4 is a view illustrating an operation of navigation satellite signal real-time generation and a clock graph according to the exemplary embodiment of the present disclosure. In the navigation satellite signal real-time generation system, the dead reckoning position calculation unit 160 may transmit (also known as perform “Position Push”) the position coordinates of a target moving object to the I/Q signal real-time generation unit 210 in a case where an FRF is on (i.e., in a state where the navigation satellite signal real-time generation device 200 generates RF signals) and simultaneously a purse per second (PPS) clock is on (i.e., in a state where clock pulses repeat “On” and “Off” a predetermined number of times per second in the clocks referenced by the navigation satellite signal real-time generation system 10). In FIG. 4, a time point at which “Position Push” occurs is indicated by a circular symbol \textcircled{1}. Thereafter, the I/Q signal real-time generation unit 210 may generate RF signals (i.e., satellite signals) by using the position coordinates transmitted from the dead reckoning position calculation unit 160, and may transmit (also known as perform “Streaming RF”) an RF generation flag, which indicates that the RF signals have been generated, to the dead reckoning position calculation unit 160. In FIG. 4, a time point at which the RF generation flag is transmitted back to the dead reckoning position calculation unit 160 is indicated by a circular symbol \textcircled{2}.

Meanwhile, reference number 400 in FIG. 4 indicates a section length in a case when a clock is in an “On” state in a PPS clock. The section length in the “On” state according to the exemplary embodiment of the present disclosure may be 500 ms. In this case, referring to the clock graph shown in FIG. 4, a difference shown on the clock graph that illustrates an auxiliary line indicating a time point at which Position Push is performed (i.e., a dotted line for “\textcircled{1}”) and an auxiliary line indicating a time point at which Streaming RF is performed (i.e., a dotted line for “\textcircled{2}”) may be less than or equal to 500 ms (in other words, up to 500 ms). In the “navigation satellite signal real-time generation system” of the present disclosure, the term “real time” may be used to refer to the fact that the difference between the time point at which the Streaming RF is performed and the time point where the Position Push is performed is set to less than or equal to 500 ms.

Meanwhile, since the related art does not have a function of generating navigation satellite RF signals in real time, there is a limitation that a navigation satellite RF signal of a mobile object can be generated only for one fixed coordinate entered. In contrast, according to the exemplary embodiment of the present disclosure as described above, as the Position Push is performed in the positioning system of the target moving object, the difference between the time point at which I/Q data is generated (i.e., “\textcircled{1}”) and the time point at which the RF signals are generated (i.e., “\textcircled{2}”) is set to be less than or equal to 500 ms, so that more accurate navigation satellite RF signals with respect to the position of the target moving object may be generated within one second. That is, by limiting the time, which is taken to convert the position coordinates of the target moving object into the navigation satellite RF signals, to “500 ms” or less, the present disclosure has an effect that the navigation satellite RF signals of the target moving object are allowed to be newly generated at intervals of less than or equal to one second even though the target moving object moves continuously and updates the position coordinates thereof.

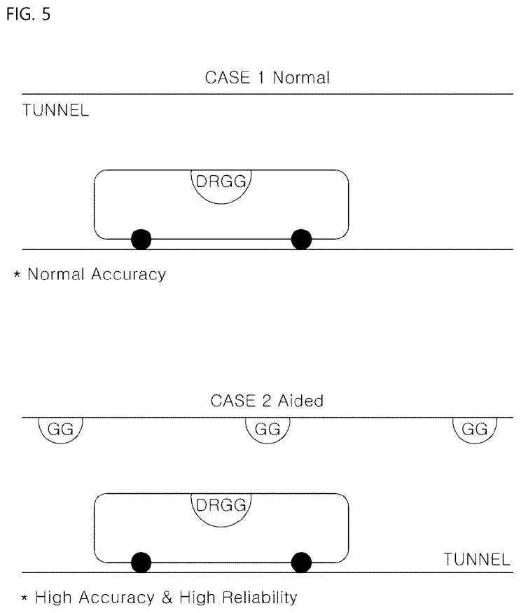

FIG. 5 is a view illustrating applied exemplary embodiment according to the exemplary embodiment of the present disclosure. In FIG. 5, “GG” represents a navigation satellite signal generator in which a Zone Positioning technique is available, and “DRGG” represents the navigation satellite signal real-time generation system using the integrated dead reckoning function according to the present disclosure.

In a first case (i.e., CASE 1) in FIG. 5, a DRGG may be mounted on a specific moving object traveling in a tunnel. In the first case, even in the tunnel where signals from satellites do not reach, the moving object may be able to calculate position coordinates of the corresponding moving object itself by using the DRGG, and may generate and transmit navigation satellite RF signals by using the position coordinates. That is, even in the inside of the tunnel like in the first case, the navigation satellite signal real-time generation system using the integrated dead reckoning function according to the present disclosure is able to provide a positioning service based on a satellite navigation system as if the moving object were in an environment where navigation satellite signals are normally received from the outside.

In a second case (i.e., CASE 2) in FIG. 5, a plurality of GGs may be arranged spaced apart from each other in a tunnel. In this case, a DRGG may be mounted on a specific moving object traveling in the tunnel. In the second case, in a case where each GG and the DRGG are operated simultaneously, accuracy may be improved by reducing an error rate compared to operating the DRGG alone as in the first case.

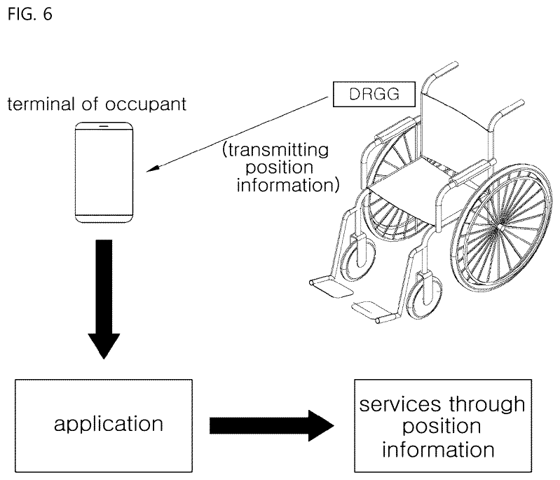

FIG. 6 is a view illustrating an applied exemplary embodiment according to the exemplary embodiment of the present disclosure.

In FIG. 6, “DRGG” represents the navigation satellite signal real-time generation system using the integrated dead reckoning function according to the present disclosure. Referring to FIG. 6, the DRGG may be mounted on a wheelchair. In this case, the DRGG may calculate a movement position of the wheelchair according to the above-described positioning method, and generate navigation satellite RF signals.

As illustrated in FIG. 6, in a case where the DRGG is mounted on the wheelchair, a wheelchair user (an individual or a group) may receive services such as route guidance and hospital room guidance, which are based on the movement positions of the wheelchair. In addition, in a case where the DRGG mounted on the wheelchair transmits navigation satellite RF signals related to position information to a terminal device (e.g., a mobile phone) of the wheelchair user, it is possible for the wheelchair user to use hospital treatment reservation services and the like through an application, etc. That is, the DRGG-based position information services may be used even in hospitals that do not have beacon terminals and the like for receiving RF signals. In addition, the position of the wheelchair occupant may also be determined in real time even outdoors.

The above description is merely an illustrative description of the technical idea of the present disclosure, and those skilled in the art will appreciate that various modifications and transformations are possible, without departing from essential characteristics of the present disclosure. Therefore, the exemplary embodiment implemented in the present disclosure is not intended to limit the technical idea of the present disclosure but to describe the present disclosure, and the scope of the technical idea of the present disclosure is not limited by the exemplary embodiment. The scope of protection of the present disclosure should be interpreted by the following claims, and all technical ideas within the scope equivalent thereto should be construed as being included in the scope of rights of the present disclosure.

1. A navigation satellite signal real-time generation system using an integrated dead reckoning function, the system generating navigation satellite signals indicating a position of a moving object, and the system comprising:
a navigation unit for generating position coordinates of the moving object by using the integrated dead reckoning function; and
a navigation satellite signal real-time generation device for exchanging data with the navigation unit in real time and generating the navigation satellite signals on the basis of the position coordinates and real-time clock information.

2. The system of claim 1, wherein the navigation unit comprises:
a receiver for receiving satellite navigation information for a plurality of navigation satellites;
one or more sensors each measuring at least one of acceleration of the moving object, a travelling speed of the moving object, or movement information of the moving object;
an integrated speed calculation unit for calculating the speed of the moving object on the basis of one or more sensor values measured from the one or more sensors;
an integrated direction calculation unit for calculating a direction of the moving object on the basis of the one or more sensor values measured from the one or more sensors; and
a dead reckoning position calculation unit for calculating the three-dimensional position coordinates of the moving object on the basis of the calculated speed of the moving object and the calculated direction of the moving object.

3. The system of claim 2, wherein the navigation satellite signal real-time generation device comprises:
an I/Q signal real-time generation unit for generating digital In-phase Quadrature-phase (IQ) signals by using the three-dimensional position coordinates received from the dead reckoning position calculation unit; and
an RF converter for converting the digital IQ signals generated by the I/Q signal real-time generation unit into radio frequency (RF) signals on the basis of the real-time clock information.

4. The system of claim 2, wherein the navigation unit further comprises:
a navigation satellite signal quality determination unit for receiving the navigation satellite signals transmitted from the receiver, determining quality of the navigation satellite signals, and requesting the dead reckoning position calculation unit to generate the position coordinates in a case where the determined quality of the navigation satellite signals is poor.

5. The system of claim 1, wherein the system is configured to generate the navigation satellite signals at least once or more per second by setting, within 500 ms, a time interval between a time point at which the navigation unit generates the position coordinates and a time point at which the navigation satellite signal real-time generation device generates the navigation satellite signals.
